(19) United States
(12) Patent Application Publication
(10) Pub. No.: US 2013/0335770 A1
(43) Pub. Date: Dec. 19, 2013

(54) IMAGE FORMING APPARATUS AND METHOD FOR CONTROLLING THE SAME

(71) Applicant: CANON KABUSHIKI KAISHA, Tokyo (JP)

(72) Inventor: Akari YASUKAWA, Yokohama-shi (JP)

(21) Appl. No.: 13/911,643

(22) Filed: Jun. 6, 2013

(30) Foreign Application Priority Data
Jun. 19, 2012 (JP) 2012-138192

(51) Int. Cl. G06F 3/12

(52) U.S. Cl. CPC G06F 3/1238
USPC 358/1.14

(57) ABSTRACT

A job history that has stored therein an executed job in a reexecutable format is searched for a reexecutable job associated with/accompanied by image data. If there is no reexecutable job, the job history is displayed in a mode in which a reexecution operation is prohibited. On the other hand, if there is a reexecutable job, user authentication is performed when an operator is a user who has not been authenticated, and a reexecution instruction of the job is received. If the executing user of the job for which the reexecution instruction was received and an authenticated logged-in user are the same user, the reexecution of the job is permitted and performed.

### BACKGROUND OF THE INVENTION

1. Field of the Invention

The present invention relates to an image forming apparatus that has, for example, a user authentication function, and stores an executed job in a reexecutable format, a method for controlling the same, and a program.

2. Description of the Related Art

In recent years, some printers provided with a memory device such as a high-capacity hard disk have a function of storing electronic document data used for a print job that has been executed once and enabling a user to select the electronic document data later so as to perform reprinting. This function makes it possible to reuse and, for example, to print an electronic document that has been printed once, thereby improving user convenience (see Japanese Patent Laid-Open No. 2010-058522 (Patent Document 2) and the like).

At the time of performing such reprinting of an electronic document, in order to protect confidentiality of the document, user access is generally restricted so that only the user who first executed printing can reexecute printing.

Also, there has been proposed a digital multi-function peripheral (hereinafter referred to merely as an “MFP”) in which restriction of use of the device is set for each user, and that has a user authentication/identification function for identifying a user who has executed a job (see, Japanese Patent Laid-Open No. 2006-172398 (Patent Document 1), for example). A user authentication method performed in this user authentication/identification function and a timing at which user authentication is performed vary according to the environment in which the MFP is used.

In Patent Document 1, for example, when an application selected among a plurality of applications provided in the device is used, it is determined according to a security level associated with this application whether or not authentication is necessary, and if it is determined to be necessary, user authentication is performed. Also, in Patent Document 2, it is determined based on predetermined information included in a print job whether or not to handle the print job as a guest job with respect to which printing and storage authority is restricted, and the job is executed on the basis of the determination result. It is also disclosed that, at the time of reprinting a stored document, stored documents of a logged-in user and stored documents of a guest user are displayed as reprintable stored documents, and a document selected from among these stored documents is subjected to reprinting.

In the case where it is determined whether or not user authentication is necessary with respect to a specific function or application, as in Patent Document 1, there are jobs that are executed without user authentication. Since the history of jobs that have been executed without user authentication does not include user identification information, jobs stored for reprinting include both jobs having user identification information and jobs having no user identification information. A user who is authenticated at the time of execution of a job and recorded in the job history is referred to as the owner of the job. With respect to a job having no such user identification information, the owner of the job cannot be specified, so it cannot correctly be determined whether or not reexecution is possible on the basis of the access authority of the user. Also, if user authentication is executed when referencing a job history in order to determine whether or not reexecution is possible, in the case where there is a guest job as in Patent Document 2, user authentication is also requested with respect to this guest job, and user convenience may be reduced as a result.

### SUMMARY OF THE INVENTION

The present invention was made in view of the above-described conventional examples, and provides an image forming apparatus that prevents unauthorized access to electronic document data recorded as a job history when reexecuting a job relating to the electronic document data, and improves user convenience, and a method for the same.

The image forming apparatus of the present invention includes the following configurations. One aspect of the present invention provides an image forming apparatus comprising: an execution unit which executes a job; a storage unit which stores a history of the job executed by the execution unit; a receiving unit which receives an instruction from a user to reexecute the job according to the history; a display unit which displays an authentication screen for authentication unit to authenticate a user; and a control unit which controls the execution unit to reexecute the job if the user who gave the instruction is a user who has been authenticated by the authentication unit, and performing control to display the authentication screen if the user who gave the instruction is a user who has not been authenticated by the authentication unit.

According to the present invention, it is possible to prevent unauthorized access to electronic document data when reexecuting a job. In addition, user convenience is improved.

Further features of the present invention will become apparent from the following description of exemplary embodiments with reference to the attached drawings.

### BRIEF DESCRIPTION OF THE DRAWINGS

FIG. 1 is a schematic diagram illustrating an overall configuration of a system.

FIG. 2 illustrates a hardware configuration of an image forming apparatus 3001.

FIG. 3 is an example of a user DB managed by the image forming apparatus 3001.

FIG. 4 is a flowchart illustrating job execution processing performed by the image forming apparatus 3001.

FIG. 5 is a flowchart illustrating PDL print job execution processing performed by the image forming apparatus 3001.

FIG. 6 illustrates an example of a job history screen displayed on an operation unit 3201.

FIG. 7 is a flowchart illustrating job reexecution processing according to a first embodiment.

FIG. 8 is a flowchart illustrating job reexecution processing performed when reexecution of a job having no user identification information is permitted.

FIG. 9 is a flowchart illustrating processing for comparing a job executing user with a logged-in user.

FIG. 10 is a flowchart illustrating job reexecution processing according to a second embodiment.

### DESCRIPTION OF THE EMBODIMENTS

### First Embodiment

Hereinafter, a mode for carrying out the present invention will be described with reference to drawings.

Overall Configuration of a System

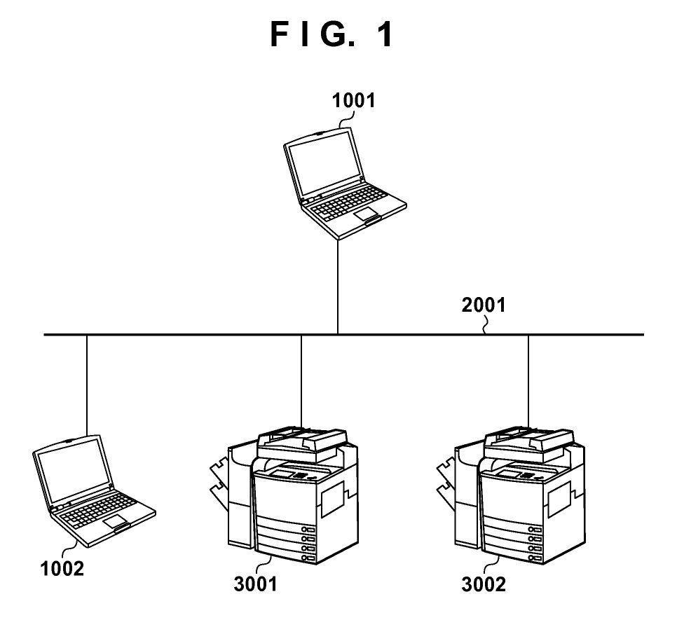

FIG. 1 is a diagram illustrating an overall layout of a system according to an embodiment of the present invention. In FIG. 1, reference numerals 1001 and 1002 denote client PCs, and reference numerals 3001 and 3002 denote image forming apparatuses each functioning as a copier and a printer, which are referred to as “digital multi-function peripherals” or “MFPs”. These devices are interconnected to each other via a LAN 2001, and thus have a function of communicating with each other via the LAN 2001. The image forming apparatuses 3001 and 3002 also have functions of transmitting and receiving data such as a document to and from another device via communication. In the case of execution of PDL printing, by a user operating the client PC 1001 or 1002, the client PC 1001 or 1002 generates print data and transmits the generated print data to the image forming apparatus 3001 or 3002 via the LAN 2001. The image forming apparatus 3001 or 3002 interprets the received print data, converts the print data into image data, and prints the image data on paper, thereby generating printed material. In the case of execution of copying, sending, or the like, by the user operating the image forming apparatus 3001 or 3002, the image forming apparatus 3001 or 3002 reads a paper document, and prints the paper document on paper or sends image data to another device. Note that the description above is an example of the configuration, and the configuration is not limited to this.

Hardware Configuration of the Image Forming Apparatuses 3001 and 3002

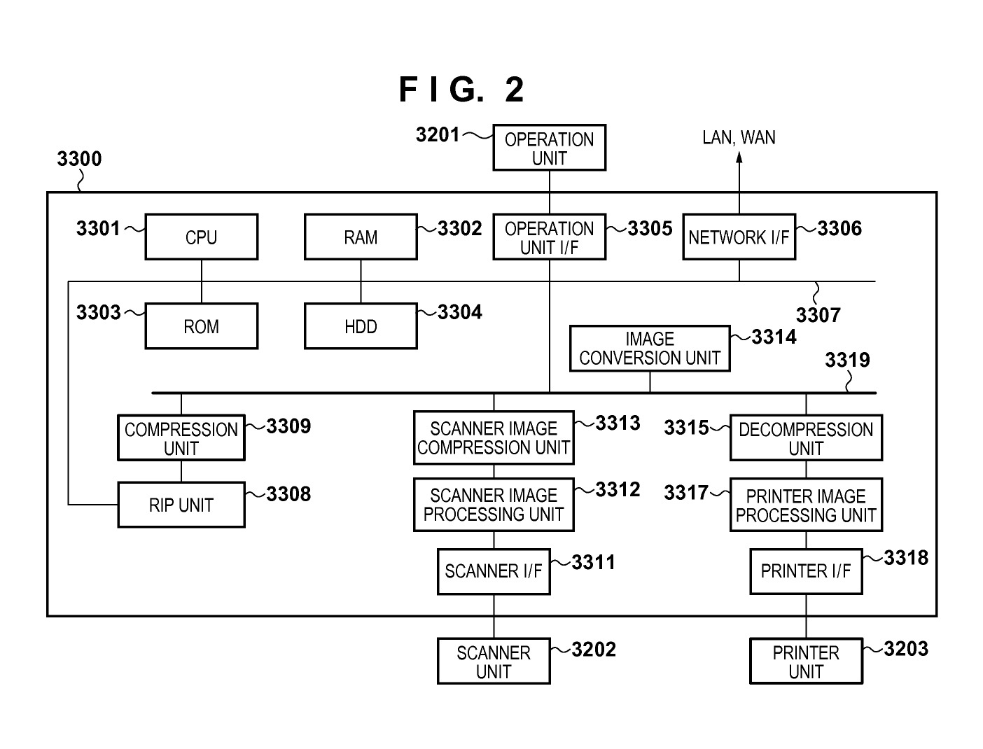

FIG. 2 is a block diagram illustrating a hardware configuration of the image forming apparatuses 3001 and 3002. The image forming apparatus 3001 is constituted by a controller 3300 for performing overall control of the image forming apparatus, a scanner unit 3202, a printer unit 3203, and an operation unit 3201. The controller 3300 is electrically connected to the scanner unit 3202 and the printer unit 3203, and further connected to the client PC 1001 or 1002, an external device, or the like via a LAN or a WAN. This makes it possible for image data or device information to be input and output.

A CPU 3301 performs overall control of access to various types of connected devices in accordance with a control program or the like that is stored in a ROM 3303, and also performs overall control of various types of processing performed within the controller 3300. A RAM 3302 is a system work memory on which the CPU 3301 operates, and serves also as a memory for temporarily storing image data. The ROM 3303 has stored therein a boot program and the like for the apparatus. An HDD 3304 is a hard disk drive and can store image data, later-described user information, and data relating to various types of jobs. The HDD 3304 stores a job history of a send job, a print job, or the like, data (image data or PDL data) of the corresponding job stored in the job history, and print setting data if there is any. Also, information relating to user authentication is stored.

An operation unit I/F 3305 is an interface unit for connecting a system bus 3307 to the operation unit 3201. This operation unit I/F 3305 receives image data to be displayed on the operation unit 3201 from the system bus 3307, and outputs the received image data to the operation unit 3201 and information input from the operation unit 3201 to the system bus 3307.

A network I/F 3306 is connected to a LAN or a WAN, and to the system bus 3307, so as to input and output information. An image bus 3319 serves as a transmission path through which image data is communicated, and is constituted by a PCI bus or an IEEE 1394 bus.

A scanner image processing unit 3312 subjects the image data received from the scanner unit 3202 via a scanner I/F 3311 to correction, processing, and editing.

A scanner image compression unit 3313 receives the image data from the scanner image processing unit 3312 and compresses the received image data. A decompression unit 3315 decompresses the data, and then subjects the data to raster deployment, sending the deployed data to a printer image processing unit 3317.

The printer image processing unit 3317 receives the image data from the decompression unit 3315, and subjects the image data to image processing with reference to attribute data attached to this image data. The image data subjected to image processing is transmitted to a printer I/F 3318 and printed on paper by the printer unit 3203.

An image conversion unit 3314 subjects the image data to predetermined conversion processing, such as rotation, color space conversion, binary to multi-valued conversion, image composition, and thinning.

A RIP unit 3308 receives intermediate data generated based on PDL code data that has been transmitted from, for example, the client PC 1001 or 1002, and generates (multi-valued) bitmap data. The generated bitmap data is compressed by a compression unit 3309, and is sent to the image bus 3319.

The User Authentication/Identification Function of the Image Forming Apparatus 3001

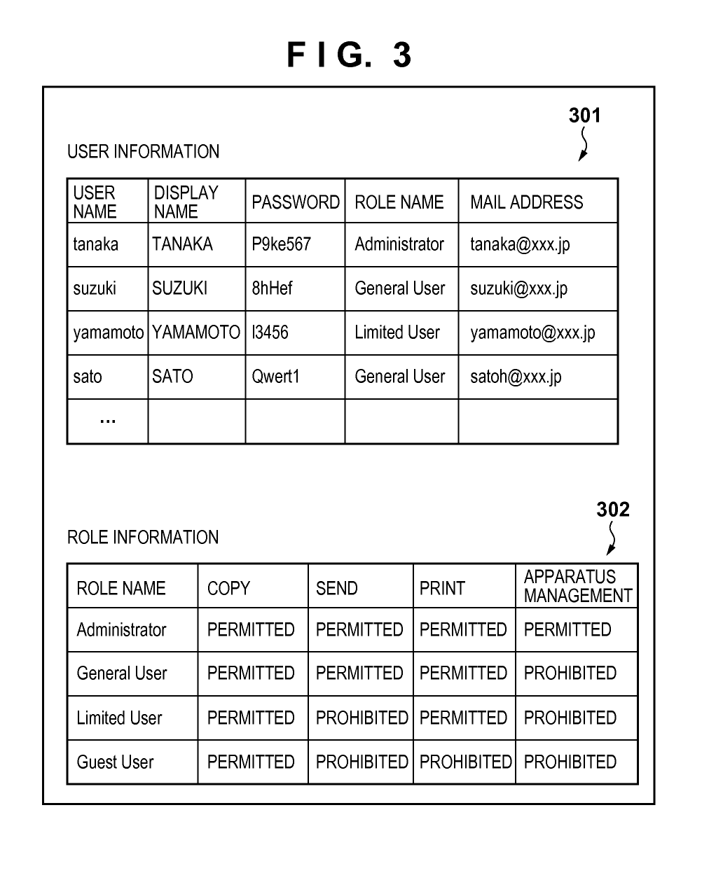

Before job execution processing performed by the image forming apparatus 3001 of the present embodiment is described, the user authentication/identification function of the image forming apparatus 3001 will briefly be described with reference to FIG. 3.

In order to perform user authentication, the image forming apparatus 3001 manages information, such as a user name and a password, as user information. The image forming apparatus 3001 also manages role information for implementing access restrictions for each user with respect to each function provided in the apparatus, in which one role is assigned to each user. The user information 301 and the role information 302 are stored, as a user DB, in the HDD 3304 of the image forming apparatus 3001. FIG. 3 illustrates information of the user DB managed by the image forming apparatus 3001. As shown in FIG. 3, the user information 301 includes “user name”, “display name”, “password”, “role name” of the role assigned to a user, and “mail address”. As role information, “role name” and information relating to whether use of each function is permitted or prohibited are managed. “User name” is identification information of a user and a value unique to the user. “Display name” is used when, for example, indicating a logged-in user or an owner of a job history. Together with “user name”, “password” is verified with input values at the time of user authentication. “Role name” is a name that corresponds to an authority defined for each role.

The role information 302 shown in FIG. 3 includes “Administrator” role, “General User” role, “Restricted User” role, and “Guest User” role. For each role, an access authority is defined with respect to each function. In the present example, the four functions of “copy”, “send” (transmission), “print”, and “apparatus management” are given, but, of course, only some of the four functions may be included or further functions may be added. Also, access authorities set for respective roles are not limited to those in FIG. 3. The “Guest User” role is used when a user who is not registered in the user DB uses the apparatus as a Guest user. When user authentication has not been executed at the time of use of the apparatus, an operator is deemed to be a Guest user and can use functions that are available for the “Guest User” role. Once user authentication has been performed, access control is implemented according to the role of the authenticated user. When a user has logged out, the user is again deemed to be “Guest user”. In FIG. 3, the “Guest User” role is only permitted to use the “COPY” function, that is, it is indicated that anyone can execute the “COPY” function without executing user authentication. In contrast, the “Send” (transmission) function is prohibited from using the “Guest User” role, so that if a Guest user tries to use the “Send” function, a user authentication screen for executing user authentication is displayed on the operation unit 3201. User authentication succeeds if a user name and a password input on the user authentication screen match with information managed in the user DB shown in FIG. 3, and the “Send” function becomes available only when the role of the authenticated user is permitted to use the “Send” function. This will be described in detail later. Here, although a method has been described in which the image forming apparatus 3001 includes the user DB and user authentication is performed, a method in which a user DB is provided on a server connected to a network and user authentication is implemented on the server is also possible.

Job Execution Processing in the Image Forming Apparatus 3001

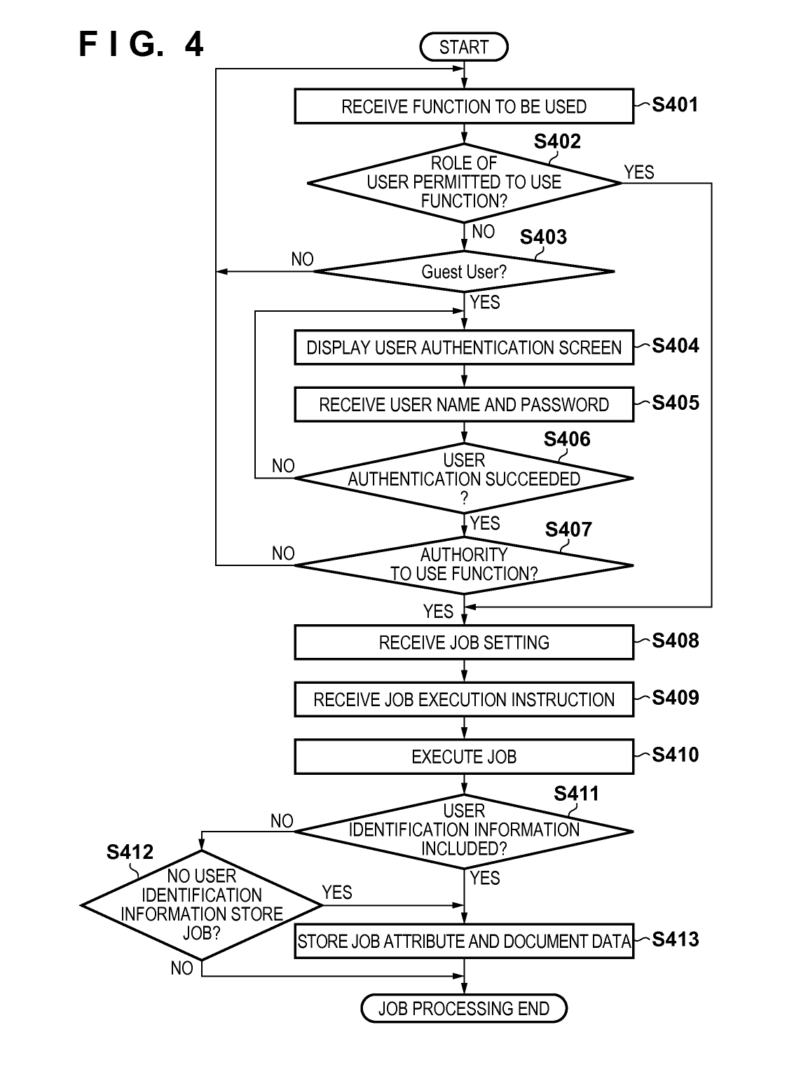

Hereinafter, processing performed when the functions of the image forming apparatus 3001 are used will be described with reference to a flowchart of FIG. 4. The processing shown in this flowchart is executed by a program being read from the ROM 3303 of the image forming apparatus 3001, deployed on the RAM 3302, and executed by the CPU 3301.

First, in step S401, an instruction of a function that the user wants to use is received, the function having been selected by the user on the operation unit 3201 of the image forming apparatus 3001. On the operation unit 3201, buttons (not shown) for respective functions such as “Copy” and “Send” are displayed, and the user presses a corresponding button of a function that he or she wants to use so as to select the function. Next, in step S402, it is determined whether or not the role of the user who gave the instruction is permitted to use the instructed function. Here, as described above, the “Guest User” role is used for comparison when user authentication has not been performed, and the role associated with the authenticated user is used for comparison when user authentication has already been performed. For example, assuming that user authentication has not been performed and the “Guest User” role is used for comparison, since the “Guest User” role is permitted to use the “Copy” function in the role information shown in FIG. 3, the “Copy” function is determined to be a permitted function, and the processing advances to step S408. In contrast, since the “Guest User” role is prohibited from using the “Send” function, the “Send” function is determined not to be a permitted function, and the processing advances to step S403.

In step S403, it is determined whether or not the role of the user is the “Guest User” role. If it is determined that the role of the user is the “Guest User” role, user authentication is assumed to have not been performed, and the processing advances to step S404 to perform user authentication. If it is determined that the role of the user is not the “Guest User” role, it is assumed that user authentication has been performed and that a function that is not available to the authenticated user has been selected, and a message indicating that use of the function is not permitted is displayed on the operation unit 3201, after which the processing returns to step S401.

In step S404, the image forming apparatus 3001 displays the user authentication screen (not shown) on the operation unit 3201. In step S405, a user name and a password input by the user on the operation unit 3201 are received. In step S406, the user name and the password received in step S405 are compared with user information of the user DB managed by the image forming apparatus 3001, and it is determined whether or not there is a matching user. If there is a matching user, user authentication is assumed to have succeeded, and the processing advances to step S407. The authenticated user name (user identification information) is stored as a logged-in user name. If there is no matching user, user authentication is assumed to have failed, an error message indicating the failure is displayed on the operation unit 3201, and the processing returns to step S404. In step S407, role information of a role associated with the authenticated user is read from the user DB, and it is determined whether or not the function instructed in step S401 is permitted. If the function is determined to be permitted, the processing advances to step S408, and if the function is determined to be prohibited, a message indicating that this function is not available is displayed on the operation unit 3201, and the processing returns to step S401.

In step S408, various types of settings for executing a job are received, and upon receipt of an instruction to start the job in step S409, the settings of the job received in step S408 are reflected on the job and the job is executed (S410). For example, if the function instructed in step S401 is the “Copy” function, the image forming apparatus 3001 controls the scanner unit 3202 so as to start to read a paper document. Then, the scanned image data is subjected to correction, processing, and editing according to the settings received in step S408, and the printer unit 3203 is controlled so as to output the image data as the paper document. Also, after execution of the job, “print time”, “job name”, “executing user name”, and the like are recorded in the job history as a log of the job execution. “Executing user name” is the user name of the user who is currently logged-in when the function is executed by an operation of the image forming apparatus 3001. The job history is stored in the HDD 3304. When execution of the job has been completed, the image forming apparatus 3001 determines, in step S411, whether or not the job has a user name, that is, user identification information. If it is determined that user identification information is included, the processing shifts to step S413, and if it is determined that user identification information is not included, the processing shifts to step S412. Here, in step S411, the image forming apparatus 3001 determines whether or not there is user identification information by determining whether or not the job has been executed by a Guest user. That is, it is determined that there is no user identification information if a logged-in user cannot be specified, and it is determined that there is user identification information if a logged-in user can be specified. Assuming that there is a user to whom the “Guest user” role is assigned, when the user is logged-in it is determined that there is user identification information, even though the role of the user is “Guest user”. In step S412, it is determined whether or not the job having no user identification information is to be stored for reuse. This determination may be performed according to settings configured in advance in the image forming apparatus 3001, or by displaying on the operation unit 3201 a dialogue for confirming whether or not the image data and settings of the executed job are to be stored, and thereby receiving an instruction from the user. If it is determined that the job having no user identification information is to be stored, the processing advances to step S413. In step S413, setting data and image data of the job are stored in the HDD 3304 for reuse of the job in association with the above-described job history. The setting data and the image data of the job to be stored may be in a format that is reexecutable by the image forming apparatus 3001. Also, information items to be stored as a job history include at least “executing user name” (that is, user identification information) and the presence or absence of associated image data, and the associated information. In addition, “execution time”, “job name”, “number of print sets”, or the like may be stored. The image data is, for example, bitmap data (or compressed data thereof) that was read from the scanner. If it is determined in step S412 that the image data is not to be stored, the job data is deleted and the job processing ends.

A configuration is also possible such that step S412 is omitted and, with respect to the job that is determined in step S411 to include no user identification information, neither the job attribute nor the image data of this job is stored.

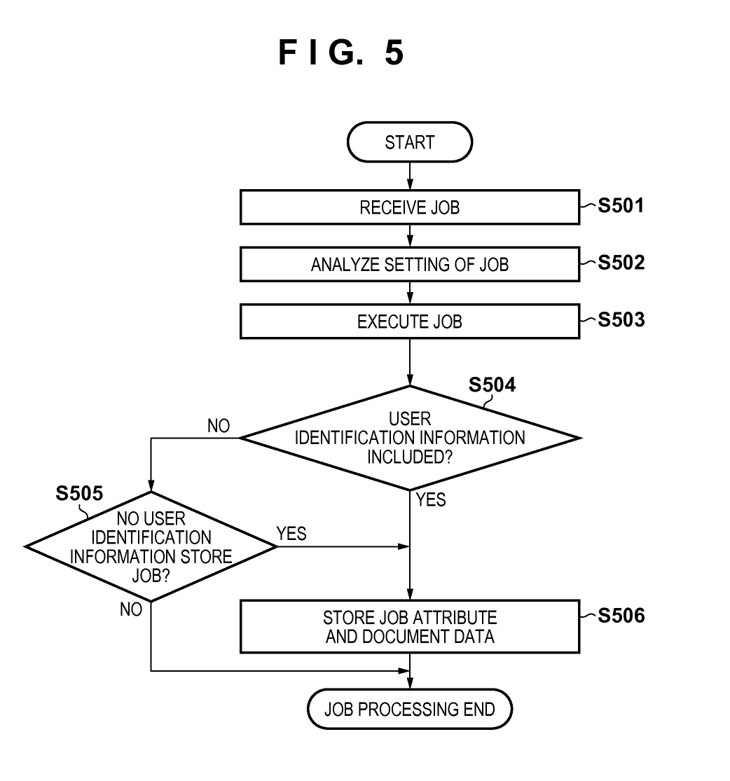

The above is the job processing executed by the image forming apparatus 3001, but when a received job like a PDL print job is executed, instructions of the user in steps S401 and S405 cannot be received by the operation unit 3201. The processing in the case of such a PDL print job will be described with reference to a flowchart of FIG. 5.

First, in step S501, the image forming apparatus 3001 receives a PDL print job via a network I/F 3306. Next, in step S502, the received PDL job is analyzed, and various types of setting information set for the job are acquired. In step S503, execution of the job, that is, printing of the received job is performed. After the execution of the job, “print time”, “job name”, “executing user name”, and the like are recorded in the job history, as a log of job execution. “Executing user name” is the user name included in the received PDL data. If a user name is not included, no user name is recorded. In step S504, it is determined whether or not the executed job has a user name (user identification information). If the setting information of the job acquired in step S502 includes user identification information of the user who instructed printing, the processing advances to step S506, and if the setting information of the job does not have such identification information, the processing shifts to step S505. In step S505, similarly to the procedure in step S412, it is determined whether or not the job having no user identification information is to be stored. Here, since an instruction of the user cannot be received using the operation unit 3201 in the case of a PDL print job, the determination of whether or not the job data is to be stored is made according to the settings that have been configured in advance for the image forming apparatus 3001 or to setting information that has been set in advance for the job. If it is determined that the job is to be stored, the processing advances to step S506 to store for reuse the settings and the image data of the job in the HDD 3304 in association with the above-described job history. If it is determined in step S505 that the job is not to be stored, the job data is deleted and the job processing ends.

Job Reexecution Processing According to the First Embodiment

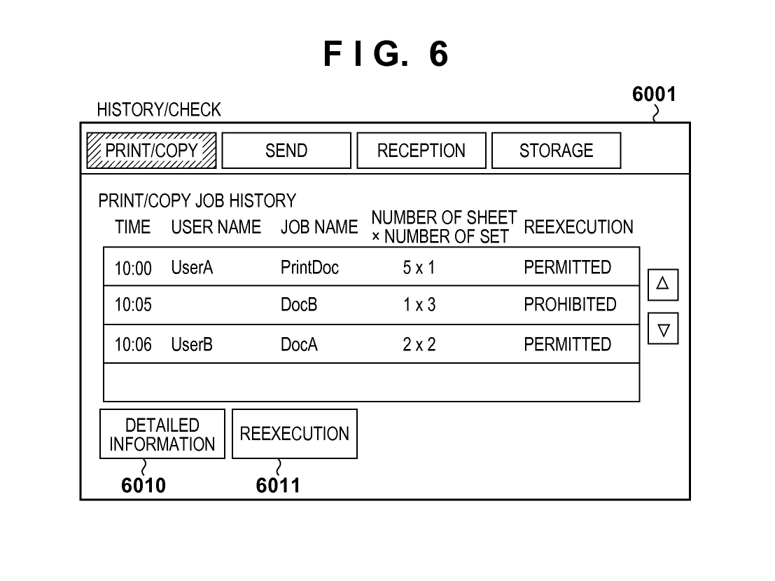

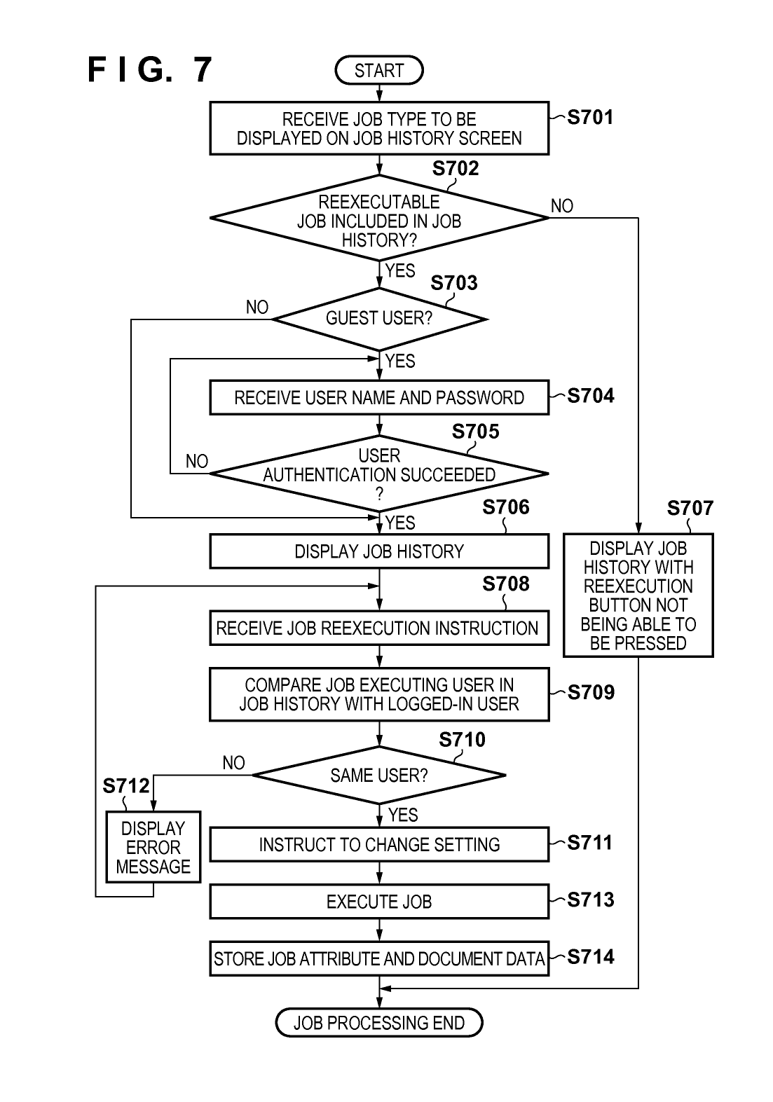

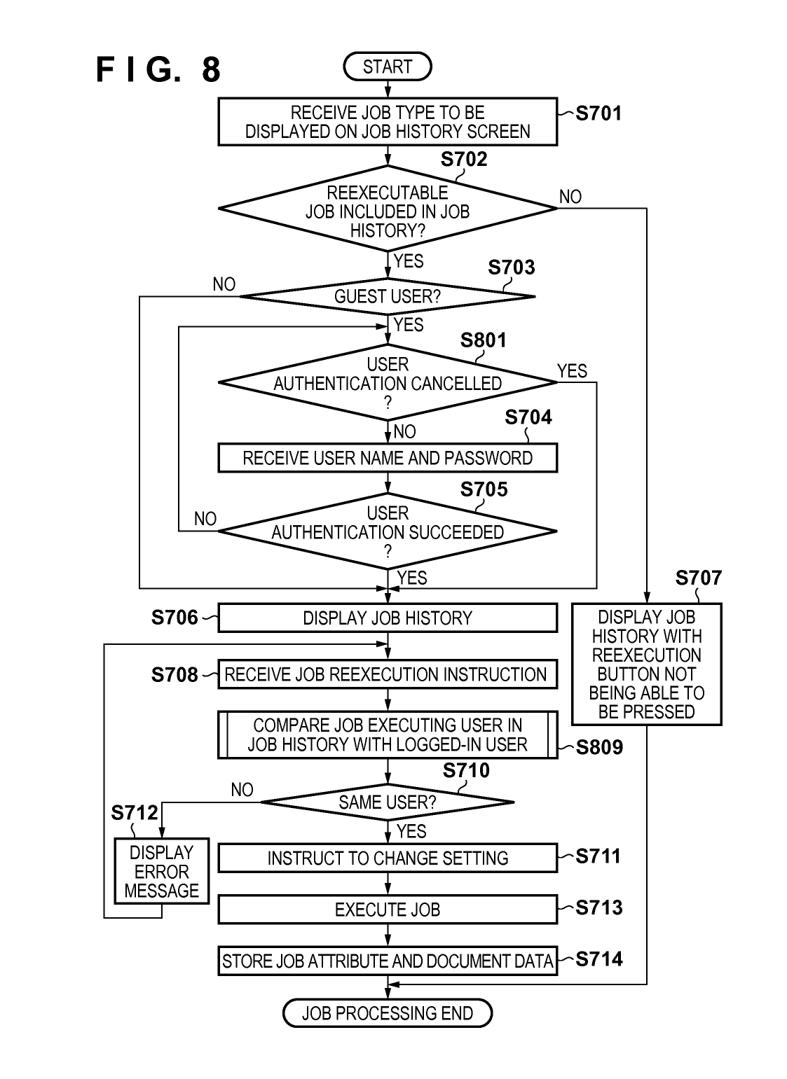

Processing for reexecuting a job from a job history performed by the image forming apparatus 3001 of the first embodiment will be described with reference to FIGS. 6 to 8. The reexecution processing varies between the case where a job having no user identification information is set to be reexecutable and the case where the job having no user identification information is set to not be reexecutable. The following will first describe the processing in the case where a job having no user identification information is set to not be reexecutable, with reference to a flowchart of FIG. 7. By acquiring the settings that have been set in advance for the image forming apparatus 3001, it is determined whether or not a job having no user identification information is set to be reexecutable. In the embodiment, if the job having no user identification information is set to be reexecutable, no executing user name can be acquired with respect to the job having no user identification information, so that it is assumed that anyone can reexecute the job. Note that instead of the processing being switched between the procedures in FIGS. 7 and 8 according to the settings, processing that is fixed to either one of the procedures of FIGS. 7 and 8 may be performed.

The processing shown in this flowchart is executed by a program being read from the ROM 3303 of the image forming apparatus 3001, deployed on the RAM 3302, and executed by the CPU 3301.

First, in step S701, a job type to be displayed on a job history screen is received by an instruction of a user. As shown in FIG. 6, in order to display a job history for each job type such as “print/copy”, “send”, or “reception”, a button of a job type is pressed, and thereby an instruction to display a job history of the corresponding job type is received. FIG. 6 will be described later. Next, in step S702, it is checked whether or not the job history of the job type received in step S701 includes a reexecutable job. As shown in the flowcharts of FIGS. 4 and 5, after the execution of the job, the job history is stored in the HDD 3304 of the image forming apparatus 3001 together with the job attribute. It is checked whether or not there is a job whose image data and job settings are recorded so as to be reexecutable in association with this job history. That is, a job whose image data and job settings are recorded in association with this job history can be determined to be a reexecutable job. If, in step S702, it is determined that no reexecutable job is included, a job history list is displayed on the operation unit 3201 (S707). FIG. 6 illustrates an example of a job history screen displayed on the operation unit 3201 of the image forming apparatus 3001. On the job history screen 6001, job histories relating to “print/copy”, “send”, “reception”, and “storage” as job types can respectively be checked, and FIG. 6 shows a job history of “print/copy”. As shown in FIG. 6, the job history includes “execution time” of the job, “executing user name” of the job, “job name”, “number of printed sheets and number of print sets”, and “permission or prohibition of reexecution (reprinting)”. When the user selects a job from the job history screen, a “detailed information” button 6010 and a “reexecution” button 6011 are enabled. When the “detailed information” button 6010 is pressed, the image forming apparatus 3001 displays on the operation unit 3201 detailed information relating to the job (e.g., a start time of the job, an end time of the job, a detailed name of the job, and the like). When the “reexecution” button is pressed, the image forming apparatus 3001 reexecutes the job, utilizing image data and setting information of the job that are associated with the job history. Since, in step S707, no reexecutable job is included, a job history screen 6001 is displayed on the operation unit 3201, with the “reexecution” button 6011 not being able to be pressed. The user can only reference the job history. Also, the job history whose job name is “DocB” includes no user name, with this indicating that the job is a job executed by a Guest user and that the user cannot be identified.

If, in step S702, it has been determined that a reexecutable job is stored, the processing advances to step S703. In step S703, as with in step S403 of FIG. 4, it is determined whether or not a logged-in user can be specified. If there is no logged-in user, the current user is determined to be a Guest user. Note that if the “Guest User” role is not permitted to be assigned to a user, the determination may be made using the role of the current user. In this case, it is checked whether or not the role of the user is the “Guest User” role. If there is no logged-in user or if it is determined that role of the user is the “Guest User” role in the case where the role is used in the determination of the user, user authentication is assumed to have not been performed and the processing advances to step S704 to execute user authentication. The procedures of user authentication in steps S704 and S705 are similar to those of steps S404 to S406 of FIG. 4, and therefore descriptions thereof are omitted. Note that although in FIG. 7 user authentication is assumed to be essential, the processing may branch to step S707 if, for example, user authentication has been cancelled in step S704. Next, in step S706, the job history is displayed. The job history is displayed as shown in FIG. 6, in which a not reexecutable job is denoted by “prohibited” and a reexecutable job is denoted by “permitted”, in the reexecution column. In this stage, even a job that is actually not reexecutable due to user access restriction is denoted by reexecution “permitted” if the image data and the like of the job are stored in association with the job history.

As described above, when a “reexecution” instruction is received from the user (S708), the executing user name of the selected job and the logged-in user name are compared in step S709. If it is determined in step S710 that the users are the same user, the job is assumed to be reexecutable and in step S711, various types of settings to be set for the job are received, and the job is executed according to the received setting contents (S713). In step S714, setting contents set when the job has been reexecuted, and document data thereof are stored in the HDD 3304, and the job processing ends. If it is determined in step S710 that the users are not the same user, an error message indicating that the job is not reexecutable is displayed on the operation unit 3201 (S712), and the processing returns to step S708. Note here that although, in the present embodiment, user names are used in step S709 for comparison between the executing user and the logged-in user, domain names may additionally be used for the comparison.

The above is the reexecution processing performed when a job having no user identification information is set to not be reexecutable. According to the present embodiment, user authentication is only performed when the job history includes a reexecutable job, so user authentication processing is limited in the case where reexecution is permitted, thereby improving user convenience.

Procedures for which a Job Having No User Identification Information is Set to be Reexecutable

The following will describe the case for which a job having no user identification information is set to be reexecutable, with reference to a flowchart of FIG. 8. The flowchart of FIG. 8 differs from the flowchart of FIG. 7 in procedures in steps S801 and S809, and the other procedures are similar to those in FIG. 7, and therefore descriptions thereof are omitted. Accordingly, by modifying, for example, FIG. 8 as follows, it is possible to realize the procedures of FIGS. 7 and 8 as a group of procedures. That is, immediately before step S801 in FIG. 8, a step for testing settings indicating whether or not a job having no user identification information is set to be reexecutable is added. If the job is set to be reexecutable, the step branches to step S801, and if the job is set to not be reexecutable, the step branches to step S704. Also, immediately before step S809, a step for testing settings indicating whether or not a job having no user identification information is set to be reexecutable is added. If the job is set to be reexecutable, a procedure in step S809 is executed, and if the job is set to not be reexecutable, a procedure in step S709 (see FIG. 7) is executed. With this configuration, it is possible to realize the procedures of FIGS. 7 and 8 as a group of procedures. Here, the settings indicating whether or not a job having no user identification information is set to be reexecutable may be the same as the settings for use in the determination in step S412 of FIG. 4. However, the description here will be given with reference to FIG. 8.

If, in step S703, it has been determined that the user is a Guest user, a user authentication screen is displayed, and in step S801, a cancellation instruction to cancel the user authentication is received. If the cancellation instruction is received in step S801, the processing shifts to step S706 and continues to reference the job history as a Guest user.

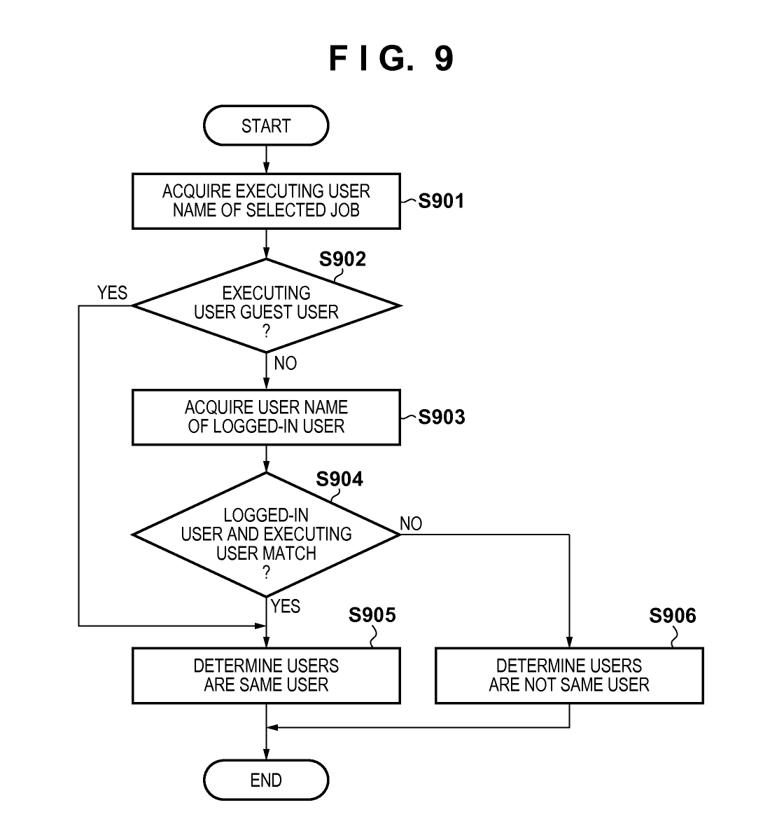

If, in step S708, a reexecution instruction is received, in step S809, the job executing user of the job history is compared with the logged-in user. FIG. 9 illustrates step S809 in detail. In FIG. 9, first the executing user name of a job selected is acquired in step S901. Next, if it is determined in step S902 that the executing user is a Guest user, that is, that the job is a job having no user identification information, it is assumed that anyone can reexecute the job and the users are determined to be the same user (S905). If it is determined in step S902 that the executing user is not a Guest user, a user name of the logged-in user is acquired in step S903. Next, in step S904, the logged-in user name is compared with the executing user name, and if the user names match each other, the users are determined to be the same user, and the processing shifts to step S905. If the user names do not match each other, the users are determined to not be the same user (S906). Here, if execution of user authentication has been cancelled in step S801, the logged-in user is deemed to be a Guest user and thus the logged-in user name will not match the executing user name, resulting in a determination that the users are not the same user. The determination results in S905 or S906 are stored, and referenced in step S710.

The above is the processing in step S809. The procedures in step S710 in FIG. 8 and the later steps are similar to those in FIG. 7, and thus descriptions thereof are omitted.

As described above, according to the present embodiment, a configuration is possible in which, at the stage of storing a job history, the entity data of a job whose user cannot be specified, e.g., its image data, is not stored as an option. This enables reexecution of a job whose owner cannot be specified to not be permitted, and enables all reexecutable jobs to be reexecuted after performing user authentication.

Meanwhile, if reexecution of a job having no user identification information is permitted, a job of a Guest user that includes no user identification information can also be reexecuted based on the job history, so that flexible access restriction is possible according to the usage method of the user.

### Second Embodiment

Job Reexecution Processing According to the Second Embodiment

In the first embodiment, it is determined whether or not to perform user authentication processing, depending on whether or not a reexecutable job is included in the job history when the job history is displayed. In the second embodiment, a method for determining whether or not to perform user authentication processing when the user instructs reexecution after the job history is displayed will be described.

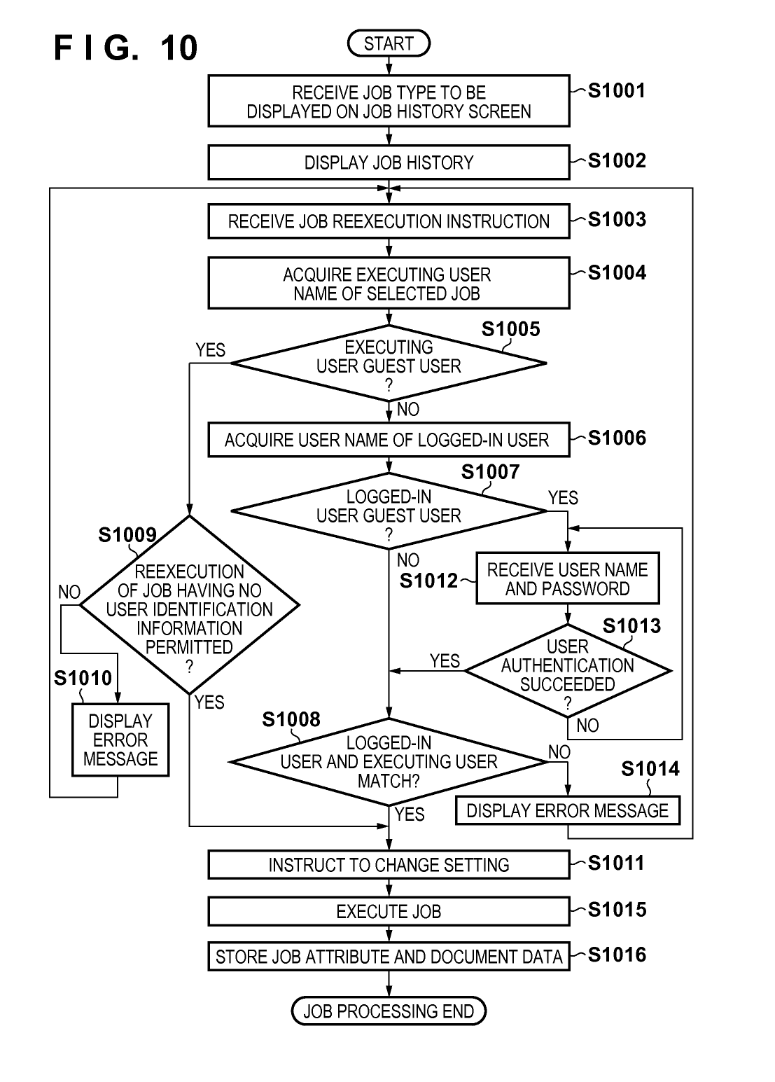

A flowchart of reexecution processing performed by an image forming apparatus 3001 of the second embodiment will be shown in FIG. 10. First, in step S1001, a job type to be displayed on a job history screen is received by an instruction of the user. Next, in step S1002, a job history of the received job type is displayed on the operation unit 3201. The job history displayed on the operation unit 3201 is similar to that in FIG. 6. If a reexecution instruction has been received from a user in step S1003, an executing user name of the selected job is acquired in step S1004. Next, if in step S1005 the executing user is determined to be a Guest user, that is, the job is a job having no user identification information, it is then determined whether or not reexecution of the job executed by a Guest user is permitted (S1009). This determination is made by acquiring settings that are set in advance in the image forming apparatus 3001. The settings for use in the determination in step S1009 may be the same settings for use in the determination in step S412 in FIG. 4. Assuming that these settings are the same as each other, if it is determined in FIG. 4 that the job is “store”, then it is determined in FIG. 10 that the job is “permitted”. If it is determined in step S1009 that the job of the Guest user is reexecutable, the processing advances to step S1011. In step S1009, if it is determined that the job of the Guest user is not reexecutable, a message indicating that the job is not reexecutable is displayed on the operation unit 3201 (S1010), and the processing returns to step S1003. If it is determined in step S1005 that the executing user is not a Guest user, a user name of the logged-in user is acquired in step S1006. If it is determined in step S1007 that the logged-in user is not a Guest user, user authentication is assumed to have been performed and the processing shifts to step S1008. If it is determined in step S1007 that the logged-in user is a Guest user, user authentication is assumed to have not been performed, the image forming apparatus 3001 displays a user authentication screen (not shown) on the operation unit 3201. In step S1012, a user name and a password that are input by the user on the operation unit 3201 are received. In step S1013, the user name and the password received in step S1012 are compared with user information of the user DB managed by the image forming apparatus 3001, and it is determined whether or not there is a matching user. If there is a matching user, user authentication is assumed to have succeeded, and the processing advances to step S1008. If there is no matching user, user authentication is assumed to have failed, and an error message indicating the failure is displayed on the operation unit 3201, returning the processing to step S1012. In step S1008, the logged-in user name is compared with the executing user name, and if these user names match each other, the user names are determined to belong to the same user, and the processing advances to step S1011. If these user names do not match each other, in step S1014, a message indicating that reexecution is prohibited is displayed on the operation unit 3201, and the processing returns to step S1003. The procedures from step S1011 onward (S1015 and S1016) are similar to procedures in steps S711 to S714 in FIG. 7, and therefore descriptions thereof are omitted.

In the second embodiment, user authentication processing is performed, by determining whether or not user authentication needs to be performed when a reexecution instruction is received in a job history, so that it is possible to omit unnecessary user authentication processing when the job history is referenced.

### Other Embodiments

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-138192, filed Jun. 19, 2012, which is hereby incorporated by reference herein in its entirety.

What is claimed is:

1. An image forming apparatus comprising:
an execution unit which executes a job;
a storage unit which stores a history of the job executed by the execution unit;
a receiving unit which receives an instruction from a user to reexecute the job according to the history;
a display unit which displays an authentication screen for authentication unit to authenticate a user; and
a control unit which controls the execution unit to reexecute the job if the user who gave the instruction is a user who has been authenticated by the authentication unit, and performing control to display the authentication screen if the user who gave the instruction is a user who has not been authenticated by the authentication unit.

2. The image forming apparatus according to claim 1,
wherein the execution unit executes a copy job, a print job, or a send job.

3. The image forming apparatus according to claim 1,
wherein the history includes at least identification information of the user who gave the instruction to execute the job, and
the control unit controls the execution unit to reexecute the job if the user who gave the instruction is a user who has been authenticated by the authentication unit and if the user who gave the instruction and a user specified by the identification information included in the history are determined to be the same user.

4. The image forming apparatus according to claim 3,
wherein the control unit determines that the users are the same user if user names match each other.

5. The image forming apparatus according to claim 3,
wherein the control unit determines that the users are the same user if user names and domain names match each other.

6. The image forming apparatus according to claim 1, further comprising the authentication unit.

7. The image forming apparatus according to claim 1,
wherein the history includes at least setting information set for the job, and
the control unit controls the execution unit to reexecute the job according to the setting information.

8. The image forming apparatus according to claim 1,
wherein the history includes at least image data of the job executed by the execution unit, and
the control unit controls the execution unit to process again the image data included in the history.

9. The image forming apparatus according to claim 8,
wherein the storage unit does not store the image data if the user who gave the instruction to execute the job executed by the execution unit cannot be specified.

10. The image forming apparatus according to claim 1,
wherein the control unit controls the execution unit to reexecute the job after the authentication screen is displayed by the display unit and user authentication is executed by the authentication unit.

11. The image forming apparatus according to claim 1, further comprising:
a unit for displaying a job history before the instruction to reexecute the job is received by the receiving unit.

12. A method that is performed by an image forming apparatus, comprising:
executing a job;
storing a history of the job executed in the executing;
receiving an instruction from a user to reexecute the job according to the history;
displaying an authentication screen for authentication unit to authenticate a user;
reexecuting the job if the user who gave the instruction is a user who has been authenticated by the authentication unit; and
displaying the authentication screen if the user who gave the instruction is a user who has not been authenticated by the authentication unit.

13. A non-transitory computer-readable storage medium that has stored therein a program for causing a computer to execute a method, the method comprising:
executing a job;
storing a history of the job executed in the executing;
receiving an instruction from a user to reexecute the job according to the history;
displaying an authentication screen for authentication unit to authenticate a user;
reexecuting the job if the user who gave the instruction is a user who has been authenticated by the authentication unit; and
displaying the authentication screen if the user who gave the instruction is a user who has not been authenticated by the authentication unit.
